(19) United States
(12) Patent Application Publication
(10) Pub. No.: US 2009/0265897 A1
(43) Pub. Date: Oct. 29, 2009

(54) Mouse Support Tray for Computer

(76) Inventor: Claude E. Haynes, Hanford, CA (US)

Correspondence Address: MARK D MILLER;KIMBLE, MACMICHAEL & UPTON, 5260 NORTH PALM AVENUE, SUITE 221, FRESNO, CA, 93704, US

(21) Appl. No.: 12/425,340

(22) Filed: Apr. 16, 2009

Related U.S. Application Data
(60) Provisional application No. 61/047,526, filed on Apr. 24, 2008.

(51) Int. Cl. A47F 7/00; G06F 3/039; A44B 21/00

(52) U.S. Cl. 24/303; 211/26; 108/91; 108/50.11

(57) ABSTRACT

The present invention includes embodiments of apparatuses, systems and methods for providing a retractable computer mouse pad for use with a portable computer or other computing device, terminal or peripheral in which the mouse pad may be extended during use, and retracted when not in use. In some embodiments a drawer-like structure is attached underneath the computing device, from which one or more mouse pads may be extended and retracted. In several embodiments, the mouse pad is provided with a magnetically attractive material, and the mouse is provided with one or more magnets for attractive engagement with such material, in order to allow the user to let go of the mouse when not in use without concern that the mouse might change position or slip off the mouse pad.

### RELATED APPLICATION

This application claims the benefit of United States Provisional Patent Application No. 61/047,526 filed on Apr. 24, 2008, which is incorporated herein by this reference in its entirety.

### BACKGROUND OF THE INVENTION

1. Field of the Invention

The present invention relates to surfaces for supporting a movable computer mouse, and more particularly to embodiments of an extendable and retractable surface for supporting a mouse used with a laptop computer or other peripheral device, accessories therefor, and related methods of use.

2. Background and Description of Related Art

Laptop computers, notebook computers and other portable computing devices are becoming increasingly popular because of their wide ranging capability coupled with portability. The speed and capacity of memory and storage in such portable units gives them the capability to efficiently support and execute large and complex programs, such as, for example, programs used for computer-aided design, or games with high quality graphics. Most programs and games generally require the use of a mouse or other device to control the position of a pointer on a screen. One of the drawbacks to portable computing devices such as laptop computers is that, because of their deliberately compact size, no support structure is provided for a mouse. Instead, in many portable computing devices, the mouse has been replaced an impression pad, a rotatable ball, or. some other device to control the position of the pointer on the screen. However, none of these devices provides the control and precision provided by the original mouse concept.

To address this situation, several different types of portable desks have been developed over the years to provide a support surface for a laptop computer with an external mouse. However, such portable desks are generally large and bulky structures that defeat the advantages gained from the reduced size of modern portable computing devices. For example, the lap board of U.S. Pat. No. 297,219 discloses a bulky structure that includes both hinged and sliding members that are attached to a large central panel. In another example, the U.S. Pat. No. 5,553,824 discloses a tray having a plurality of elongated shallow, parallel strengthening ribs, but the tray is wider and deeper than the laptop computer it. is designed to support, and it does not provide-any surface for use as a mouse pad. Other developments suffer to from similar drawbacks.

Therefore, there is a need for apparatuses, systems and methods for conveniently providing. a mouse support pad for use with a portable electronic computing device without increasing the overall dimensional profile of the device, or otherwise defeating the advantages gained from the reduced size of the computing device.

### SUMMARY OF THE INVENTION

Embodiments of the present invention include apparatuses, systems and methods for providing a retractable computer mouse pad for use with a portable/laptop computer or other computing device, terminal or peripheral in which the mouse pad may be extended during use, and retracted when not in use. Embodiments of the invention include a drawer-like structure that may be attached either temporarily or permanently underneath the computing device, from which the mouse pad may be extended and retracted. The mouse pad itself may include one or more lips at its edge(s) for restricting the movement of the mouse in order to prevent it from being moved off the pad. In alternative embodiments, an extendable mouse pad may be provided on one side (e.g. right side), the opposite side (e.g., the left side), or on both sides of the support structure.

In some embodiments, the mouse pad or a portion of the upper surface thereof may be made of or include a magnetically attractive material such as steel, and the mouse may be provided with one or more magnets for attractive engagement with such material. In other embodiments, the mouse pad itself or a portion of the upper surface thereof may be magnetic or include a magnetic portion, and one or more magnetically attractive strips may be provided on the mouse. These embodiments allow the user to let go of the mouse without concern that it may change position or slip off the mouse pad.

It is therefore an object of the present invention to provide a convenient retractable mouse support pad for use with a laptop computer or other portable computing device, terminal or peripheral.

It is also an object of the present invention to provide a support structure for a retractable mouse pad that may be attached underneath a laptop computer or other portable computing device, terminal or peripheral without significantly expanding the overall profile of such device.

It is also an object of the present invention to provide a support structure for attachment underneath a laptop computer or other portable computing device, terminal or peripheral that includes a retractable mouse pad, and a mouse, in which the mouse and pad are magnetically attracted to each other, allowing the user to let go of the mouse during use without concern that it may change position or slip of the mouse pad.

These and other objects, advantages, and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of an embodiment of the present invention showing a tray member in a retracted position.

FIG. 2 is a perspective view of the embodiment of FIG. 1 showing the tray member in an extended position.

FIG. 3 is an exploded view illustrating tray and mouse embodiments of the invention.

FIG. 4 is a detailed perspective view of an embodiment of a tray of the present invention.

FIG. 5 includes detailed views of some exemplary accessories for use with embodiments of the present invention.

FIG. 6 is a detailed view of an embodiment of a mouse of the present invention.

FIG. 7 is a perspective environmental view of an exemplary embodiment of the present invention.

### DETAILED DESCRIPTION

The invention, in its various aspects, is explained in greater detail below. While the invention is described herein in conjunction with several exemplary embodiments, the exemplary embodiments themselves do not limit the scope of the invention. Similarly, the exemplary embodiments as illustrated in the accompanying drawings, wherein like or similar reference characters designate like or corresponding parts throughout the several views and examples, do not limit the scope of the exemplary embodiments and/or of the invention.

It is to be appreciated that although the invention is described in conjunction with laptop computers, embodiments of the invention may be used with any computer, computer system, terminal or peripheral (portable, desktop, notebook, hand-held, etc.) having an underside to which embodiments of the present invention may be attached. It is also to be appreciated that embodiments of the present invention may be provided in different sizes and shapes for use with different sized computers, computer systems, terminals, peripherals, and the like.

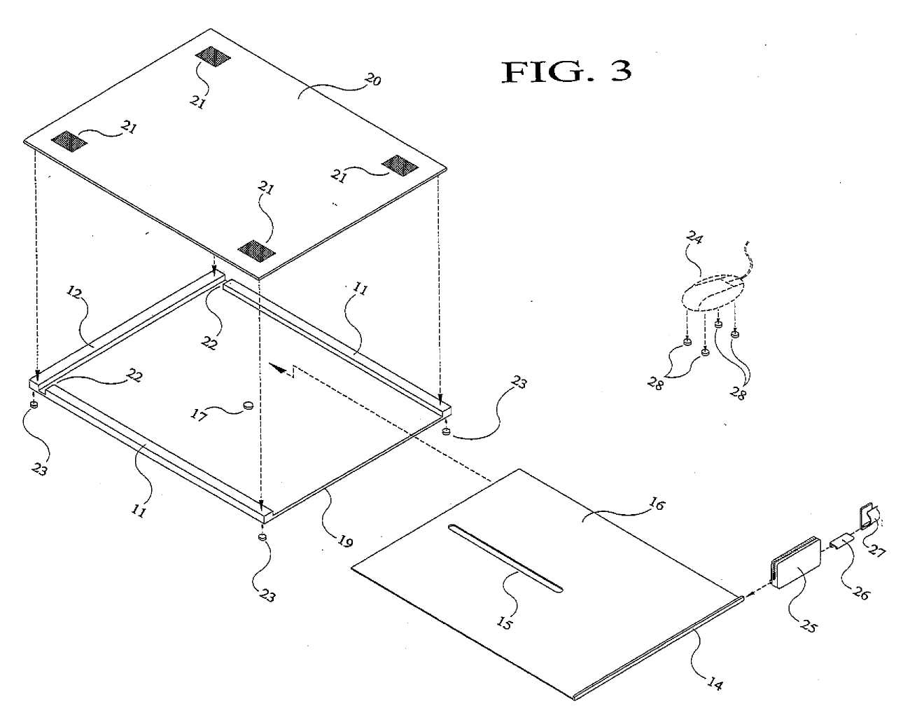

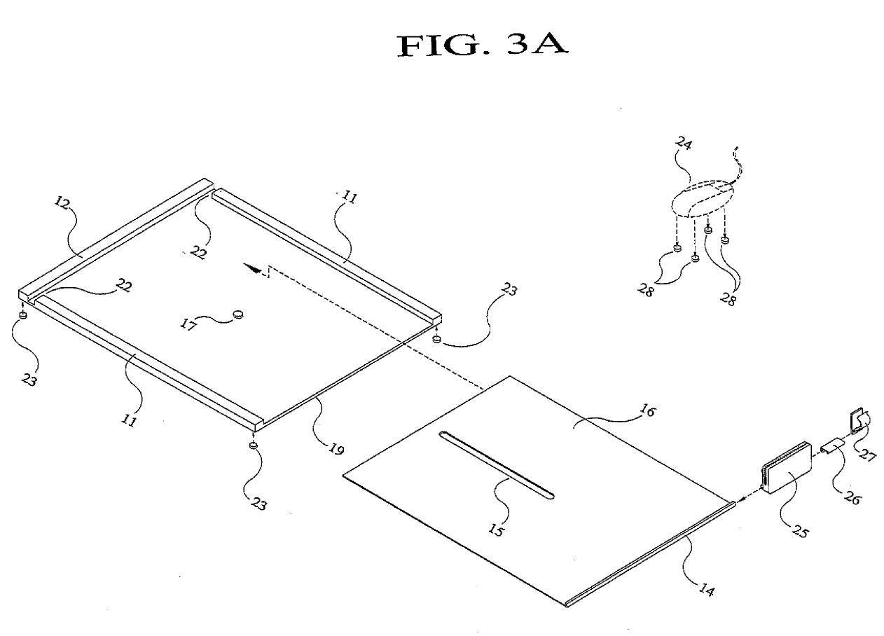

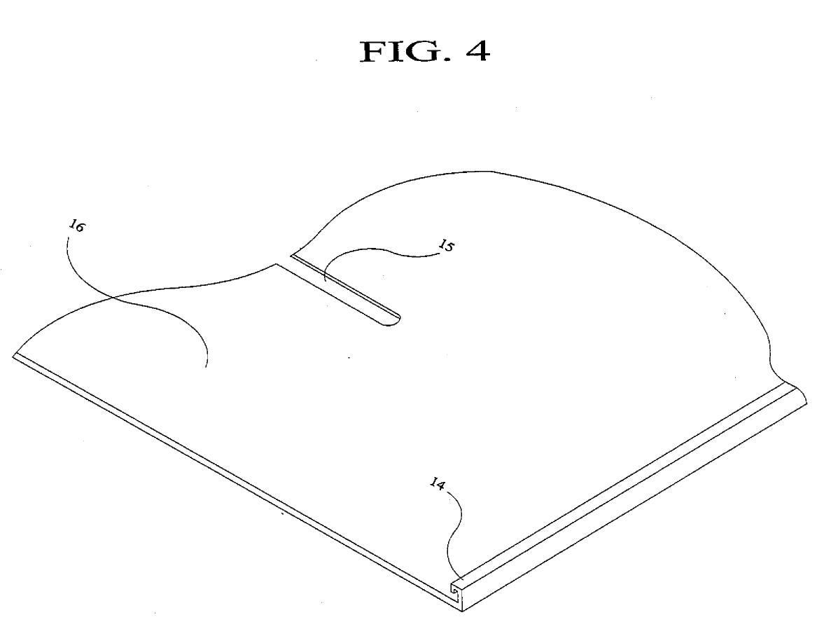

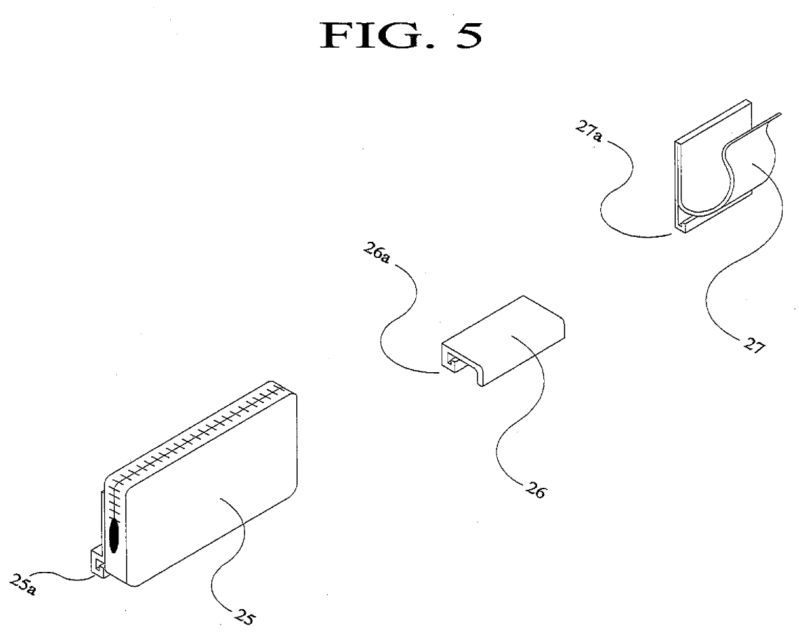

Referring to the exemplary illustrated embodiments, and particularly to FIG. 3, it is seen that embodiments of the invention include a lower panel or tray 19 having at least a pair of elongated ridges or spacers 11 located along opposite edges of tray 19, Ridges 11 are preferably oriented in a generally parallel relationship to each other in order to define a central area on tray 19 for receiving a flat slidable mouse support panel 16. Support panel 16 is sized so as to fit between ridges 11 so that it may be moved from an extended to a retracted position, or to any position therebetween, by sliding it against an upper surface of tray 19 in a fashion like that of a drawer. In this regard, ridges 11 act as guides to limit the sliding movement of panel 16 against tray 19. In preferred embodiments, ridges 11 are provided along the top and bottom (front and back) of tray 19, so that panel 16 may extend out from either the left or the right side.

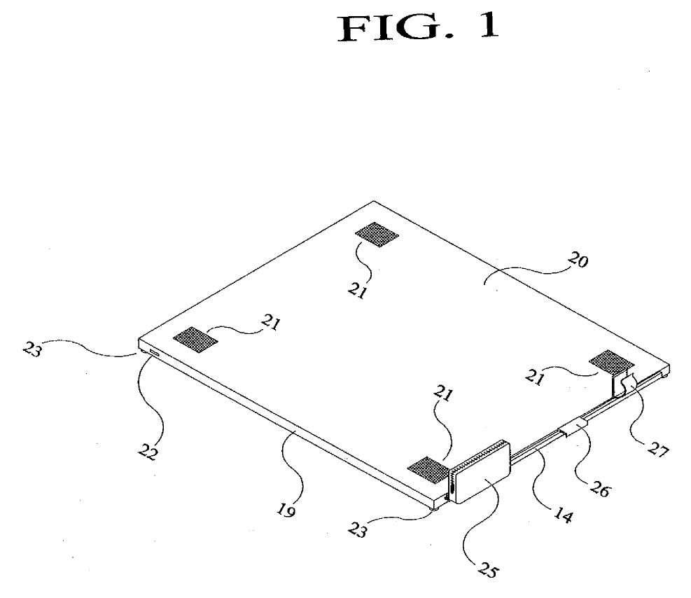

In embodiments of the invention, a lip 14 is provided along some or all of an outer edge of mouse support panel 16. The lip may extend the entire length of the edge of panel 16 in order to provide a barrier at the edge of panel 16 to prevent the mouse 24 from being moved off of panel 16. It is to be appreciated that in embodiments of the invention, the outer edge of panel 16 and/or tray 19 may be straight or curved, for example, to provide more room for manipulating the mouse 24. For storage and transportation purposes, to avoid damage and to take up less space, it is preferable for panel 16 to be able to retract so that lip 14 is flush or nearly flush with the edge of tray 19 and/or the edge of the computing device to which it is attached, as shown in FIG. 1. In some embodiments (not shown) an upper and/or lower lip may also be provided on panel 16 to provide additional barrier(s) to limit the movement of the mouse 24, to keep it on panel 16 during use. In these embodiments, corresponding slots are provided in the opening above tray 19 for receiving these additional lips when panel 16 is pulled in and out.

In alternative embodiments, a shorter version of lip 14 may be provided which may, for example, act as a handle for pulling tray 16 in and out. Lip 14 also provides a location where accessories for the computer and mouse may be attached. These accessories may include, without limitation, an easily grasped pull-out handle 26 for moving panel 16 in and out; a clip 27 for holding the mouse when not in use; and/or a pouch 25 for storing small items such as the mouse, cable, batteries, writing implements, paper clips, erasers and the like.

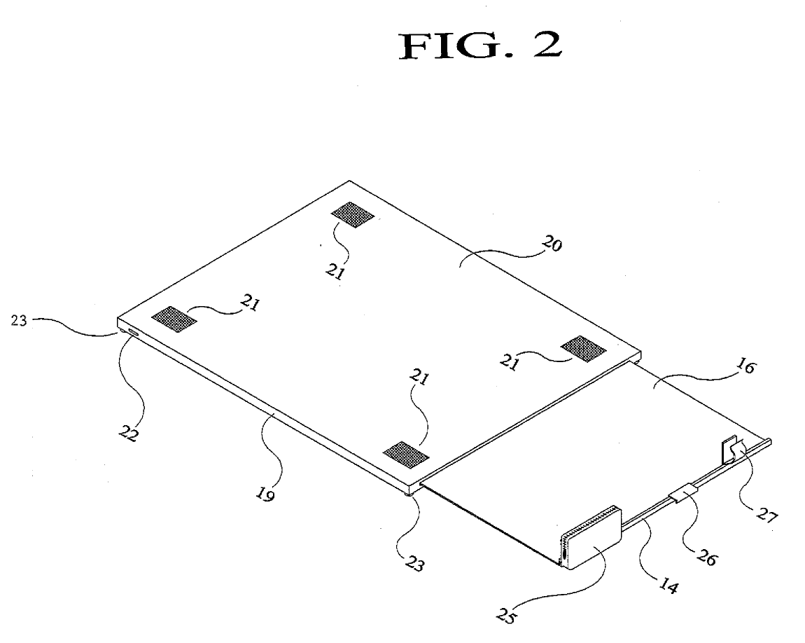

In some embodiments of the invention, an upper panel 20 is provided adjacent to tray 19. In these embodiments, ridges 11 are sandwiched between trays 19 and 20 thereby defining an interior space where the movable mouse support panel 16 may be deployed like a drawer. In some embodiments, upper panel 20, lower panel 19 and ridges 11 may be provided as a single unit, as shown in FIGS. 1-2. In the embodiments having panel 20, the upper surface of panel 20 is designed to be attached to the underside of the laptop or other computer or peripheral. This attachment may temporary or permanent, and may be accomplished by any suitable means, such as the use of double sided adhesive pads, hook-and-loop (Velcro®) engagement pads, clips, straps, screws, or other similar structures. It is to be appreciated that in some embodiments, panel 20 may be permanently attached to the underside of the computer or peripheral using, for example, a suitable adhesive, epoxy or a bonding agent.

It is to be appreciated that in alternative embodiments such as that illustrated in FIG. 3A, upper panel 20 may be eliminated, such that ridges 11 and/or 12 may be used to attach tray 19 to the underside of the computer, either temporarily or permanently, in a fashion similar to that described above using, for example, double sided adhesive pads, hook-and-loop (Velcro®) engagement pads, clips, straps, screws, or other similar structures, or permanent adhesive.

In some embodiments, a ridge 12 may be provided at the end of tray 19 opposite from the opening where panel 16 is received, as shown in FIG. 3. Ridge 12 prevents tray 16 from being inserted too far, and also acts as a barrier to prevent excessive dust and debris from entering the interior space where tray 16 is slidably deployed. In some embodiments, gaps or channels 22 may 15. be provided at the corners where ridges 11 and 12 meet, to allow any dust or debris that has entered the interior space to be pushed or emptied out.

In other embodiments, instead of ridge 12, dual support panels 16 may be provided, one that may be extended out from the left side, and another that may extended out from the right side of tray 19. It is to be appreciated that in different embodiments, panel(s) 16 may be provided to extend out from the left side, from the right side, or from both sides of tray 19.

In some embodiments, a centrally located knob 17 is provided on tray 19, and a corresponding elongated slot 15 is provided on panel 16, as shown in FIG. 3. Knob 17 provides a central support/spacer to between the center of tray 19 and either panel 20 or the underside of the computer. This avoids unnecessary friction against panel 16 which might otherwise occur from the middle of tray 19 collapsing or pressing against either panel 20 or the underside of the computer. Slot 15 on panel 16 allows panel 16 to slidably move against tray 19, with slot-and-knob 15-17 acting as both a guide for panel 16, and as a stop to prevent panel 16 from sliding completely out from tray 19 under the computer.

In some embodiments, support panel 16 is may be made from a magnetically attractive metal such as steel, or panel 16 may have an upper surface some or all of which includes or is made from such a material. In these embodiments, at least one magnet 28 is provided on the underside of the mouse 24 for temporary engagement with the magnetically attractive surface of panel 16. The use of such a panel 16 with a magnetically attachable mouse 24 allows the position of panel 16 to be moved or tipped away from horizontal without the mouse moving or sliding off. This provides a high level of convenience when used, for example, with an associated laptop computer, since the mouse will stay in place on panel 16 despite tipping, tilting and other movement of the computer. It is preferred that the magnet(s) used have sufficient strength to hold mouse 24 in place against panel 16 even if panel 16 is tilted from a horizontal to a vertical orientation. This improves efficiency since the user need not worry about the mouse falling off, or losing a current orientation or position. In alternative embodiments, panel 16 itself or some or all of its upper surface may be magnetic, and one or more magnetically attractive metal strips may be provided on the associated mouse 24 for attractive engagement with surface 16.

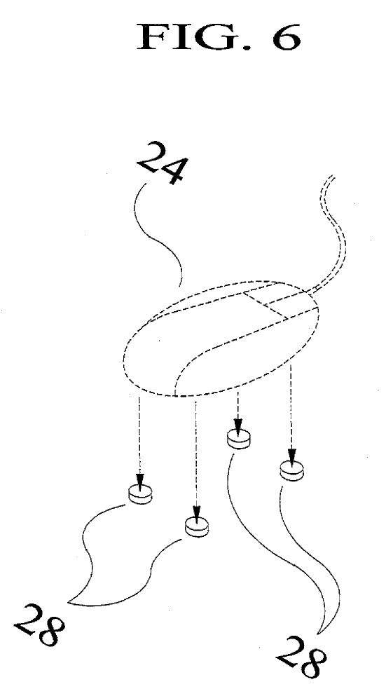

In the illustrated embodiments of FIGS. 3 and 6, the exemplary mouse is shown with four magnetic feet (or metal strips) 28, although any suitable number of such feet/strips may be provided. It is preferred that an optically communicating mouse be used in the embodiments using the magnetically attachable mouse, since the thickness of the magnet(s)/strip(s) may cause a traditional track ball on the mouse to lose contact with the upper surface of panel 16. However, any suitable mouse may be fitted with appropriate magnetic or metallic strips in order to accomplish magnetic attraction between the mouse 24 and panel 16 during use.

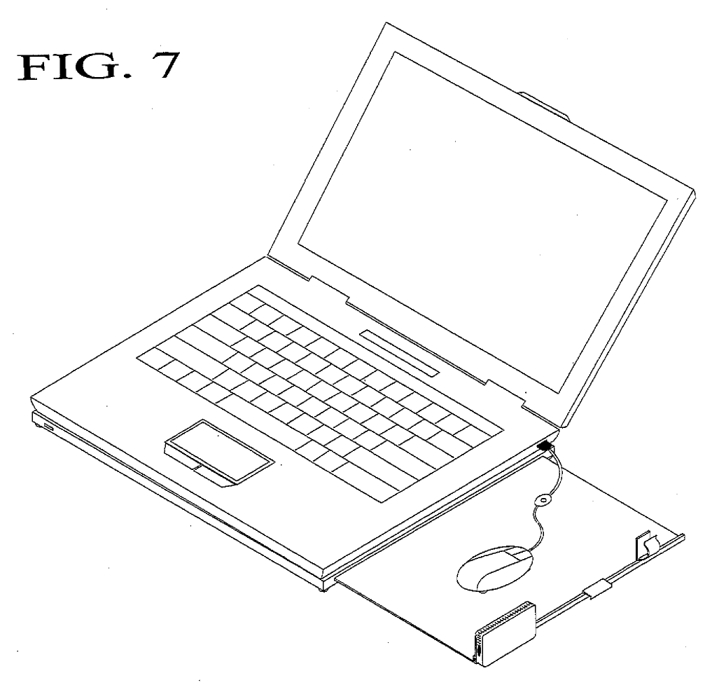

Most of the embodiments of the present invention are designed to be attached underneath a laptop or portable computer, as illustrated in the exemplary embodiment of FIG. 7. Such embodiments are installed by attaching some portion of either the upper surface 20, or of the strips 11 (and/or strip 12, when provided), to the underside of the computer. In some embodiments one side of a hook-and-loop (Velcro®) engagement pad 21A (not shown) may be attached to the underside of the computer, and the complementary side of the hook-and-loop engagement pad 21 may be attached at a corresponding position on either surface 20 or strip(s) 11 (and/or 12). One or two large set of pads 21A/21, or a plurality of smaller sets of pads 21A/21 may be used. Engaging the complementary pads will hold panel 20 and the remainder of the apparatus to the underside of the computer. In other embodiments, one or more screws may be provided on a portion of the upper surface 20, strip(s) 11, and/or strip 12 for engagement with corresponding holes in the base of the underside of the computer. In some embodiments, padded, rubberized or magnetic feet 23 may be attached to the underside of panel 19 to allow the unit to be used on a smooth table top without excessive sliding.

As an exemplary application of an embodiment of the present invention, and without limitation, a typical laptop or portable computer may be adapted for use with an external mouse 24 and a support structure of the present invention by attaching the support structure underneath the computer, either by attaching ridges 11 (and 12, when provided), or upper panel 20, to the bottom surface of the computer. The user must then obtain a suitable external mouse (preferably an optically operated one) for use with the computer, and attach either one or more magnets 28, or one or more magnetically attractive strips, to the underside of the mouse. Panel 16 should be made of or have an upper surface that either partially or completely includes a complementary material: either the surface on panel 16 is magnetically attractive (when magnets 28 are used on the mouse), or the surface on panel 16 itself is magnetic (when magnetically attractive strips are used on the mouse). Panel 16 may then be slid out from the side underneath the laptop computer, to act as the mouse pad for mouse 24. The user need not hold mouse 24 against pad 16 at all times during use, even if pad 16 is tilted or tipped, since the magnetic attraction will keep mouse 24 in place against pad 16 when not being manipulated by the user. When not in use, mouse 24 may be placed in clip 27 or returned to pouch 25, and panel 16 slid out of the way under the computer.

In use, the single 19 or dual panels 20 and the space for movable panel 16 provide a layer of insulation and ventilation between the lap of the user (or a table top) and the warm lower surface of the laptop computer, terminal or other peripheral device.

In some embodiments, ball bearings or other structures may be provided on tray 19 to improve ease of sliding panel 16. In some embodiments a lock may be provided to fix the position of panel 16 anywhere between its fully extended and fully retracted positions. In some embodiments, a spring or other biasing device may be provided to automatically retract panel 16 when released.

It is to be understood that different combinations, permutations, and variations of the various features of the present invention may be made without departing from the scope thereof. As such, one or more features of some of the exemplary or illustrated embodiments identified herein may be practiced in conjunction with one or more features of other exemplary or illustrated embodiments. For example, and without limitation, an embodiment may include only a lower tray 19, strips 11, and slidable panel 16 such that ships 11 are attached directly to the underside of a computer; whereas, without limitation, another embodiment may include both lower and upper trays 19 and 20, strips 11 and 12, slidable panel 16, knob 17, slot 15 and engagement means 21 for attachment underneath a computer; and other embodiments may include different combinations of these and/or other elements of the invention. It is also to be understood that the present invention is not to be limited by the specific embodiments disclosed herein or as illustrated in the referenced drawings, but rather, is defined in accordance with the appended claims when read in light of the foregoing specification.

What is claimed is:

1. A support for a mouse used with a portable computer comprising:
a. a tray for deployment underneath the computer, said tray having a flat surface and a first and a second upwardly protruding ridge, wherein the first and second ridges are generally parallel to each other and provided near opposite. edges of the tray;
b. a mouse support panel slidably provided on said tray between said first and second ridges for supporting the mouse; and
c. a lip provided along at least a portion of an edge of said mouse support panel.

2. The support of claim 1 wherein at least a portion of each of said first and second ridges is removably attached to an underside of said computer.

3. The support of claim 1 further comprising. a third upwardly protruding ridge on said tray positioned generally perpendicular to said first and second ridges, said third ridge extending from a location near an end of said first ridge to a corresponding location near an end of said second ridge.

4. The support of claim 3 wherein at least a portion of each of said ridges is removably attached to an underside of said computer.

5. The support of claim 3 wherein a first gap is provided between said end of said first ridge and said third ridge, and a second gap is provided between said end of said second ridge and said third ridge.

6. The support of claim 1 wherein a top panel is provided adjacent to said tray and engaged with said first and second ridges, wherein an interior space is defined between said tray and said top panel for receiving said mouse support panel.

7. The support of claim 6 wherein at least a portion of an outer surface of said top panel is removably attached to an underside of said computer.

8. The support of claim 1 wherein an upwardly protruding knob is provided on said tray and an elongated slot is provided on said mouse support panel for engagement with said knob.

9. A mouse and support pad for use with a computer comprising:
a. a tray for deployment underneath the computer, said tray having a flat surface and a first and a second upwardly protruding ridge, wherein the first and second ridges are generally parallel to each other and provided near opposite edges of the tray;
b. a mouse support panel slidably provided on said tray between said first and second ridges for supporting the mouse, wherein said mouse support panel comprises a magnetically attractive portion; and
c. at least one magnet located on an underside of said mouse for movable attractive engagement with said magnetically attractive portion of said mouse support panel.

10. A mouse pad for use with a portable computer comprising:
a. a lower panel having a flat surface;
b. an upper panel having a flat surface;
c. a pair of generally parallel elongated spacers located between said upper and lower panels and near opposite edges thereof defining a space between said upper and lower panels; and
d. a mouse support panel slidably provided in said space.

11. The mouse pad of claim 10 wherein at least a portion of an upper surface of said upper panel is removably attached to an underside of said computer.

12. The mouse pad of claim 10 further comprising a third spacer located between said upper and lower panels, wherein a first gap is provided between said third spacer and a first of said pair of spacers and a second gap is provided between said third spacer and a second of said pair of spacers.

13. The mouse pad. of claim 10 further comprising a third spacer on said lower panel positioned generally perpendicular to said pair of spacers, said third spacer extending from a location near an end of a first of said pair of spacers to a corresponding location near an end of a second of said pair of spacers, wherein a first gap is defined between the first of said pair of spacers and said third spacer and a second gap is defined between the second of said pair of spacers and said third spacer.

14. The mouse pad of claim 10 wherein a centrally located knob is provided between said upper and lower panels, and an elongated slot is provided on said mouse support panel for engagement with said knob.

15. The mouse pad of claim 10 wherein a lip is provided along at least a portion of an outer edge of said mouse support panel.

16. In combination, a computer mouse pad and mouse comprising:
a. a pair of flat panels attached together along parallel longitudinal edges defining an interior space accessible through an opening;
b. a mouse support panel slidably provided in said space and extendable through said opening, wherein said mouse support panel comprises a magnetically attractive portion; and
c. a mouse for use with said computer, said mouse having at least one magnet located on an underside thereof for movable attractive engagement with said magnetically attractive portion of said mouse support panel.

17. The combination of claim 16 wherein at least one portion of an upper surface of one of said flat panels is removably attached to an underside of said computer.

18. The combination of claim 16 wherein a centrally located knob is provided between said flat panels, and an elongated slot is provided on said mouse support panel for engagement with said knob.

19. The combination of claim 16 wherein a lip is provided along at least a portion of an outer edge of said mouse support panel.

20. A process for adapting a portable computer for use with an external mouse comprising the steps of:
a. attaching to an undersurface of said computer a portion of a drawer unit, said drawer unit having a slot for slidably receiving a pad having a magnetically attractive portion;
b. attaching at least one magnet to an undersurface of said mouse;
c. pulling out said slidable pad;
d. magnetically engaging said at least one magnet to said magnetically attractive portion of said pad; and
e. slidably moving said mouse on said pad to control the computer.
